(19) United States
(12) Patent Application Publication
(10) Pub. No.: US 2010/0295865 A1
(43) Pub. Date: Nov. 25, 2010

(54) DISPLAY METHOD AND COLOR SEQUENTIAL DISPLAY

(75) Inventors: CHIEN-LIANG WU, Tainan County (TW); Kuan-Hsu Fan-Chiang, Tainan County (TW); Chia-Cheng Lai, Tainan County (TW)

Correspondence Address: J C PATENTS, 4 VENTURE, SUITE 250, IRVINE, CA, 92618, US

(73) Assignee: Himax Display, Inc., Tainan County (TW)

(21) Appl. No.: 12/470,805

(22) Filed: May 22, 2009

(51) Int. Cl. G06F 3/038; G09G 5/02

(52) U.S. Cl. 345/589; 345/213

(57) ABSTRACT

A color sequential display and a display method using the same are provided. The color sequential display displays a frame in a frame period. The frame includes a plurality of sub-frames. The frame period includes a plurality of sub-frame periods corresponding to the sub-frames. In the display method, a first color light source is turned on according to a first duty cycle within a first sub-frame period for displaying a first sub-frame. Next, a second color light source is turned on according to a second duty cycle within a second sub-frame period for displaying a second sub-frame. Finally, the first color light source and the second color light source are respectively turned on according to a first modified duty cycle and a second modified duty cycle. The first modified duty cycle and the second modified duty cycle are proportioned to the first and the second duty cycles.

### BACKGROUND OF THE INVENTION

1. Field of the Invention

The present invention relates to a color sequential display and a display method using the same, more particularly, to a display method that adjusts duration of different color frame periods for displaying.

2. Description of Related Art

Along with the maturation of photoelectric technology and semiconductor manufacturing technology, flat panel displays are developed rapidly. Liquid crystal displays (LCDs) advantageous in low-voltage operation, non-radiation, light weight, and small volume have gradually replaced conventional cathode-ray tube displays to become mainstream display products in the market. An LCD mainly includes a liquid crystal (LC) panel and a backlight module. As liquid crystals injected into the LC panel do not emit light by themselves, the LC panel must be lightened by a plane light source provided by the backlight module so as to enable the LCD to display.

Traditionally, a white light source, e.g., a cold cathode fluorescent lamp (CCFL), is configured in the backlight module for displaying different colors through color filters disposed on each pixel region. There are three color filters, e.g., red, green, and blue, disposed on each pixel region for mixing colors in spatial domain. As a result, not only manufacturing costs are increased, but also light transmission through the color filters is poor. In addition, a color deviation would be perceived by human eyes in boundaries between those color filters, so that a black matrix is employed to separate the color filters for resolving the color deviation problem. However, the light transmission is decreased all the more by the black matrix.

In recent years, light emitting diodes (LEDs) are gradually used to replace the conventional white light source for displaying different colors of a pixel. Instead of mixing colors in a spatial domain, three primary colors of light, e.g., red, green, and blue, emitted by the LEDs are mixed in a temporal domain. In other words, these colors are rapidly switched to display within a visual persistence time interval of human eyes. Hence, there is no need to dispose the color filters, and the light transmission can be efficiently increased.

FIG. 1 is a diagram of a color sequential display method. Referring to FIG. 1, a frame includes a red (R) sub-frame, a green (G) sub-frame, and a blue (B) sub-frame, which are respectively displayed during equal sub-frame periods T_{R}, T_{G}, and T_{B} composing a frame period. When the red sub-frame is displayed during the sub-frame period T_{R}, red data are first transmitted to a source driver. The source driver converts the red data into driving voltages and then transmits the driving voltages to corresponding pixels within a data transmission time t_{DR}. In the meanwhile of transmitting the driving voltages to pixels on a display panel, the orientation direction of liquid crystal (LC) is changed in response to the driving voltages, so that a LC response time t_{LC} is necessary for phase transition of LC. After the LC response time t_{LC}, the red LEDs of the backlight module are lighted up for an optical display time t_{BR} to provide a red backlight to the display panel so as to display the red sub-frame. To reason by analogy, the green sub-frame and the blue sub-frame are sequentially displayed during the sub-frame periods T_{G} and T_{B}.

With regard to the identical optical display times t_{BR}, t_{BG}, and t_{BB}, brightness of the red, green, and blue backlights are different in accordance with currents for driving different color LEDs, and light transmissions of LC correspond to different color backlights. As a result, the frame may not be displayed under a preset white balance. According to the related art, that there are two methods for adjusting the frame to reach the preset white balance.

In the first method, the brightness of one of the red, green, and blue backlights is adjusted to the maximum, and the others are decreased to reach the preset white balance. Nevertheless, as being limited by the attenuated brightness of the backlights, the light source can not achieve its optimal performance. In the second method, under the circumstance that the sub-frame periods T_{R}, T_{G}, and T_{B} are identical, one of the optical display times t_{BR}, t_{BG}, and t_{BB} is adjusted to the maximum, and the other optical display times are decreased to reach the preset white balance. The utilization efficiency of the light source is decreased since the idle time in the sub-frame period can not be efficiently utilized. Besides, the brightness of light perceived by human eyes is related to the duration of the backlight, so that the decrement of the optical display time may cause the displayed frame to have lower brightness.

### SUMMARY OF THE INVENTION

Accordingly, the present invention provides a display method that can enhance the optical performance and the work efficiency of a color sequential display.

A display method for a color sequential display to display a frame in a frame period is provided. The frame includes a plurality of sub-frames, and the frame period includes a plurality of sub-frame periods corresponding to the sub-frames. In the display method, a first color light source is turned on according to a first duty cycle within a first sub-frame period for displaying a first sub-frame. Next, a second color light source is turned on according to a second duty cycle within a second sub-frame period for displaying a second sub-frame. Finally, the first and the second color light sources are turned on according to a first and a second modified duty cycles within a compensation sub-frame period, respectively, wherein the first modified duty cycle and the second modified duty cycle are proportioned to the first duty cycle and the second duty cycle.

In an embodiment of the foregoing display method, the first duty cycle and the second duty cycle are determined in response to a color temperature of the frame.

In an embodiment of the foregoing display method, a ratio of the first modified duty cycle to the second modified duty cycle is substantially equal to a ratio of the first duty cycle to the second duty cycle.

In an embodiment of the foregoing display method, the first duty cycle is unequal to the second duty cycle.

In an embodiment of the foregoing display method, the first sub-frame period is unequal to the second sub-frame period in accordance with the first duty cycle and the second duty cycle.

In an embodiment of the foregoing display method, the compensation sub-frame period is determined upon the maximum of the first modified duty cycle and the second modified duty cycle.

In an embodiment of the foregoing display method, the display method further includes turning on a third color light source according to a third duty cycle within a third sub-frame period for displaying a third sub-frame.

In an embodiment of the foregoing display method, the first, the second, and the third duty cycles are determined in response to a color temperature of the frame.

In an embodiment of the foregoing display method, the display method further comprises turning on the third color light source according to a third modified duty cycle within the compensation sub-frame period, wherein the third modified duty cycle is proportioned to the third duty cycle.

In an embodiment of the foregoing display method, a ratio of the first modified duty cycle to the third modified duty cycle is substantially equal to a ratio of the first duty cycle to the third duty cycle.

In an embodiment of the foregoing display method, the compensation sub-frame period is determined upon the maximum of the first, the second, and the third modified duty cycles.

In an embodiment of the foregoing display method, colors of the first, the second, and the third color light sources are corresponding to primary colors of light.

A color sequential display is provided in the present invention. The color sequential display displays a frame in a frame period. The frame includes a plurality of sub-frames, and the frame period includes a plurality of sub-frame periods corresponding to the sub-frames. The color sequential display includes a luminaire device, a control module, and a display panel. The luminaire device turns on a first color light source according to a first duty cycle within a first sub-frame period. Next, the luminaire device turns on a second color light source according to a second duty cycle within a second sub-frame period, and the luminaire device turns on the first and the second color light sources respectively according to a first modified duty cycle and a second modified duty cycle within a compensation sub-frame period. The control module determines the first modified duty cycle and the second modified duty cycle respectively proportioned to the first duty cycle and the second duty cycle. The display panel displays a first, a second, and a compensation sub-frames in response to the luminaire device during the first, the second, and the compensation sub-frame periods, respectively.

In an embodiment of the foregoing color sequential display, the control module determines the first duty cycle and the second duty cycle in response to a color temperature of the frame.

In an embodiment of the foregoing color sequential display, a ratio of the first modified duty cycle to the second modified duty cycle is substantially equal to a ratio of the first duty cycle to the second duty cycle.

In an embodiment of the foregoing color sequential display, the first duty cycle is unequal to the second duty cycle.

In an embodiment of the foregoing color sequential display, the first sub-frame period is unequal to the second sub-frame period in accordance with the first duty cycle and the second duty cycle.

In an embodiment of the foregoing color sequential display, the compensation sub-frame period is determined upon the maximum of the first modified duty cycle and the second modified duty cycle.

In an embodiment of the foregoing color sequential display, the luminaire device further turns on a third color light source according to a third duty cycle within a third sub-frame period, and the display panel displays a third sub-frame during the third sub-frame period.

In an embodiment of the foregoing color sequential display, the luminaire device further turns on the third color light source according to a third modified duty cycle within the compensation sub-frame period, and the control module determines the third modified duty cycle proportioned to the third duty cycle.

The present invention provides the display method and the color sequential display that refer to the color temperature of the frame to determine the duration of the duty cycles and the compensation duty cycles during the compensation sub-frame periods. For achieving white balance, the compensation duty cycles are proportioned to the duty cycles in response to the color temperature of the frame. Hence, the optical performance of the color sequential display can be enhanced.

In order to make the aforementioned features and advantages of the present invention comprehensible, embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a color sequential display method.

FIG. 2A is a block diagram of a color sequential display according to an embodiment of the present invention.

FIG. 2B is a diagram of a display method for the color sequential display according to the embodiment of FIG. 2A.

FIG. 2C is a flow chart of a display method for the color sequential display according to the embodiment of FIG. 2A.

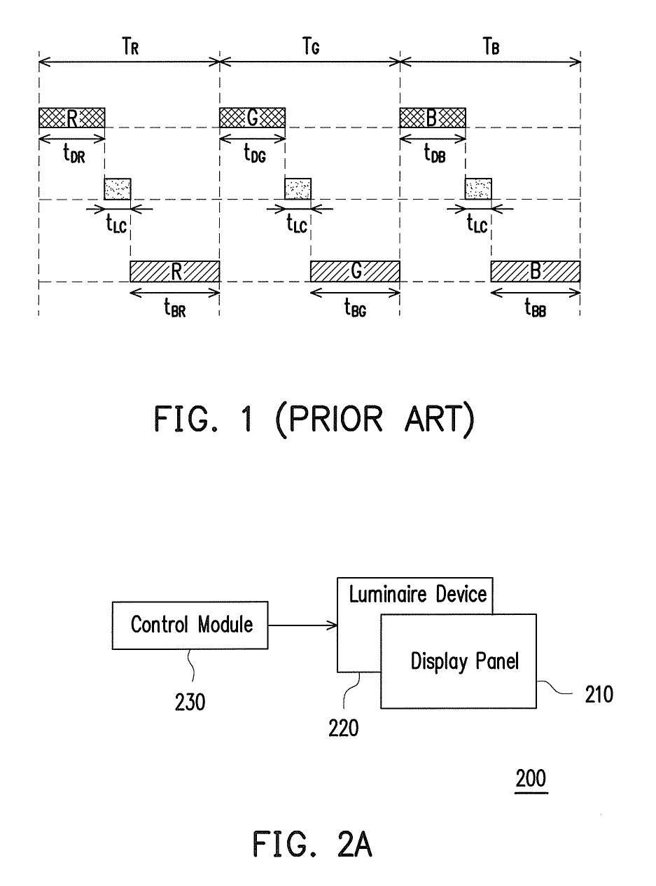

### DESCRIPTION OF EMBODIMENTS

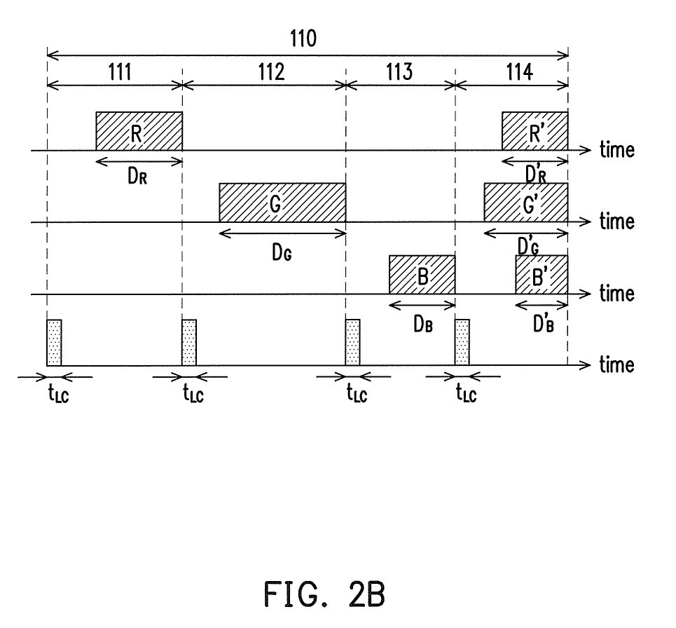

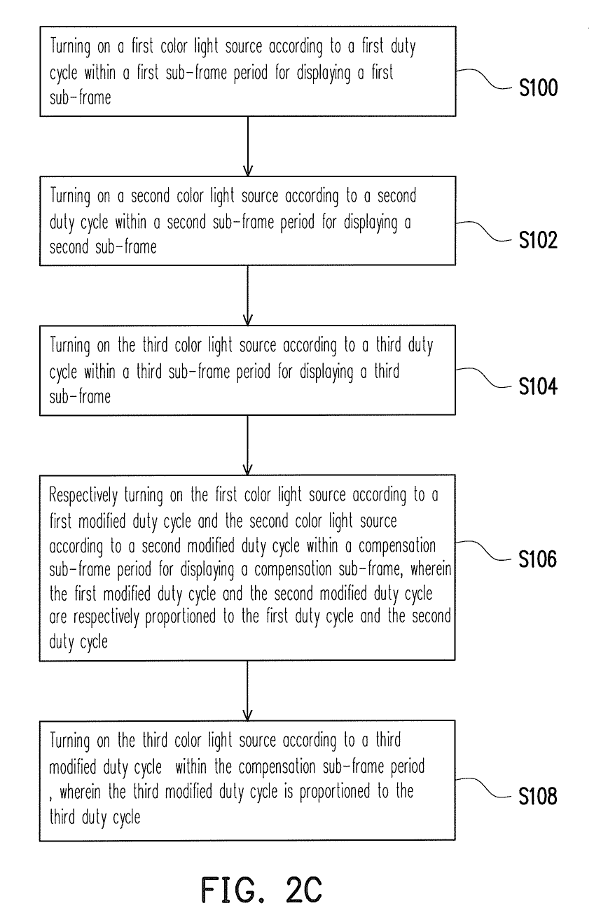

FIG. 2A is a block diagram of a color sequential display according to an embodiment of the present invention. FIG. 2B is a diagram of a display method for the color sequential display in the embodiment of FIG. 2A. Referring to FIG. 2A and FIG. 2B, the color sequential display 200 displays a frame during a frame period 110. The frame includes a plurality of sub-frames with different colors. These sub-frames are switched to display in axis of time (i.e., in the so-called temporal domain). In other words, these sub-frames are respectively displayed during a plurality of sub-frame periods 111 through 114 of the frame period 110, e.g., a red sub-frame R during sub-frame periods 111, a green sub-frame G during sub-frame periods 112, a blue sub-frame B during sub-frame periods 113, and a compensation sub-frame during a compensation sub-frame period 114.

The color sequential display 200 includes a display panel 210, a luminaire device 220, and a control module 230. In the embodiment of the present invention, it is assumed that the sub-frames of red, green, blue and the compensation sub-frame are sequentially displayed. As shown in FIG. 2B, the sub-frame period 111 includes a liquid crystal (LC) response time t_{LC} and a red duty cycle D_{R}; the sub-frame period 112 includes the LC response time t_{LC} and a green duty cycle D_{G}; the sub-frame period 113 includes the LC response time t_{LC} and a blue duty cycle D_{B}. During the red duty cycle D_{R}, the green duty cycle D_{G}, and the blue duty cycle D_{B}, the luminaire device 220 respectively turns on a corresponding color light source.

Referring to FIG. 2A and FIG. 2B, when a red sub-frame R is displayed during the sub-frame period 111, the data of the red sub-frame R are transmitted to the display panel 210 for driving pixels (not shown); meanwhile, the orientation direction of LC disposed in the display panel 210 is changed for the LC response time t_{LC}. After the LC response time t_{LC}, the luminaire device 220 turns on a red color light source according to the red duty cycle D_{R} within the sub-frame period 111 so that the display panel 210 displays the red sub-frame R.

Similarly, analogies can be drawn to display a green sub-frame G and a blue sub-frame B. After the LC response time t_{LC}, the luminaire device 220 turns on a green color light source according to the green duty cycle D_{G} within the green sub-frame period 112, so that the display panel 210 displays the green sub-frame G, and after the LC response time t_{LC}, the luminaire device 220 turns on a blue color light source according to the blue duty cycle D_{B} within the blue sub-frame period 113, so that the display panel 210 can display the blue sub-frame B.

In the embodiment of the invention, the red duty cycle D_{R}, the green duty cycle D_{G}, and the blue duty cycle D_{B} are determined by the control module 230, and the red duty cycle D_{R}, the green duty cycle D_{G}, and the blue duty cycle D_{B} are in response to a color temperature of the frame so as to achieve a white balance of the frame. Generally, a color temperature is a significant characteristic of visible light, and the color perceived by human eyes varies with the color temperature. The color temperature can be referred to as adjusting the duty cycles, so that variations in the embodiment can be adapted to different light sources. Note that in the embodiment, the red duty cycle D_{R} is unequal to the green duty cycle D_{G}, and the sub-frame period 111 is unequal to the sub-frame period 112 in accordance with the red duty cycle D_{R} and the green duty cycle D_{G}. Since the sub-frame periods can be adjusted in accordance with the duty cycle, an idle time in the sub-frame period can be efficiently utilized. Hence, the color sequential display 200 can achieve the white balance by adjusting the duration of the duty cycles upon which the sub-frames are regulated, so that the optical performance and the work efficiency of the color sequential display 200 can be enhanced.

Besides, the embodiment of the control module 230 determines a red modified duty cycle D_{R}′, a green modified duty cycle D_{G}′, and a blue modified duty cycle D_{B}′ respectively proportioned to the red duty cycle D_{R}, the green duty cycle D_{G}, and the blue duty cycle D_{B}. After the control module 230 determines the red modified duty cycle D_{R}′, the green modified duty cycle D_{G}′, and the blue modified duty cycle D_{B}′, the luminaire device 220, e.g., a light emitting diode (LED), respectively turns on the red color light source, the green color light source, and the blue color light source according to the red modified duty cycle D_{R}′, the green modified duty cycle D_{G}′, and the blue modified duty cycle D_{B}′ during the compensation sub-frame period 114. Hence, the display panel 210 displays the compensation sub-frame during the compensation sub-frame period 114. In the embodiment, the compensation sub-frame is substantially a white sub-frame so as to decrease a color breakup (CBU) of the frame, and the white sub-frame in this embodiment is composed of a red compensation sub-frame R′, a green compensation sub-frame G′, and a blue compensation sub-frame B′.

Specifically, the red modified duty cycle D_{R}′, the green modified duty cycle D_{G}′, and the blue modified duty cycle D_{B}′ can be designed according to following equations:

D_{R}′=D_{R}×D %

D_{G}′=D_{G}×D %

D_{B}′=D_{B}×D %

, where 0≦D≦100 and D is a ratio of the modified duty cycle to the duty cycle. In the embodiment, a ratio of the red modified duty cycle D_{R}′ to the green modified duty cycle D_{G}′ is substantially equal to a ratio of the red duty cycle D_{R} to the green duty cycle D_{G}. Similarly, a ratio of the red modified duty cycle D_{R}′ to the blue modified duty cycle D_{B}′ is substantially equal to a ratio of the red duty cycle D_{R} to the blue duty cycle D_{B}. In addition, the compensation sub-frame period 114 in the present embodiment is determined upon the maximum of the red modified duty cycle D_{R}′, the green modified duty cycle D_{G}′, and blue modified duty cycle D_{B}′. That is, compensation sub-frame period 114=Max (D_{R}′, D_{G}′, D_{B}′). For example, if the green modified duty cycle D_{G}′ is the maximum of the red modified duty cycle D_{R}′, the green modified duty cycle D_{G}′, and blue modified duty cycle D_{B}′ (as shown in FIG. 2B), the compensation sub-frame period 114 is determined upon the green modified duty cycle D_{G}′.

Certainly, since the compensation sub-frame period 114 is determined upon the maximum of the red modified duty cycle D_{R}′, the green modified duty cycle D_{G}′, and blue modified duty cycle D_{B}′ which are respectively determined upon the red duty cycle D_{R}, the green duty cycle D_{G}, and the blue duty cycle D_{B}, it is merely required to adjust the red duty cycle D_{R}, the green duty cycle D_{G}, and the blue duty cycle D_{B} so as to achieve the white balance of the frame, which greatly reduces difficulties in an adjustment. More specifically, if the white color presented by the frame is slightly blue, the green duty cycle D_{B} is reduced to achieve the white balance of the frame, and so is the blue modified duty cycle D_{B}′ during the compensation sub-frame period 114. In addition, since the brightness of light perceived by human eyes is related to the duration of the backlight (i.e. the duty cycle and the modified duty cycle), the brightness (intensity) of the compensation sub-frame and the brightness (intensity) of the red, green, and blue sub-frames may be adjusted to the same by adjusting the red modified duty cycle D_{R}′ to be equal to the red duty cycle D_{R}, by adjusting the green modified duty cycle D_{G}′ to be equal to the green duty cycle D_{G}, and by adjusting the blue modified duty cycle D_{B}′ to be equal to the blue duty cycle D_{B}. In other words, the brightness (intensity) can be enhanced by adjusting the ratio of the red modified duty cycle D_{R}′ to the red duty cycle D_{R} to be 100% (i.e D %=100%), by adjusting the ratio of the green modified duty cycle D_{G}′ to the green duty cycle D_{G} to be 100%, and by adjusting the ratio of the blue modified duty cycle D_{B}′ to the blue duty cycle D_{B} to be 100%, and the intensity of the compensation sub-frame and the red, green, and blue sub-frames would be the same. Hence, the intensity of the compensation sub-frame can be increased or decreased by increasing or decreasing the ratio of the red modified duty cycle D_{R}′ to the red duty cycle D_{R}, the ratio of the green modified duty cycle D_{G}′ to the green duty cycle D_{G}, or the ratio of the blue modified duty cycle D_{B}′ to the blue duty cycle D_{B}.

FIG. 2C is a flow chart of a display method for the color sequential display according to the embodiment of FIG. 2A. Referring to FIG. 2A and FIG. 2C, first, step S100 is carried out. A first (red) color light source is turned on according to a first duty cycle (the red duty cycle D_{R}) within a first sub-frame period (the sub-frame period 111) for displaying a first (red) sub-frame. Next, step S102 is carried out. A second (green) color light source is turned on according to a second duty cycle (the green duty cycle D_{G}) within a second sub-frame period (the sub-frame period 112) for displaying a second (green) sub-frame.

Thereafter, step S104 is carried out. The third (blue) color light source is turned on according to a third duty cycle (the blue duty cycle D_{B}) within a third sub-frame period (the sub-frame period 113) for displaying a third (blue) sub-frame. Note that the color of the first color light source can be another color (e.g. green, blue, and so on) in another embodiment, which can also be applied to the color of the second color light source and the color of the third color light source.

Next, step S106 is carried out. The first (red) color light source according to a first modified duty cycle (the red modified duty cycle D_{R}′) and the second (green) color light source according to a second modified duty cycle (the green modified duty cycle D_{G}′) are respectively turned on within a compensation sub-frame period (the compensation sub-frame period 114) for displaying a compensation sub-frame, wherein the first modified duty cycle (the red modified duty cycle D_{R}′) and the second modified duty cycle (the green modified duty cycle D_{G}′) are proportioned to the first duty cycle (the red duty cycle D_{R}) and the second duty cycle (the green duty cycle D_{G}), respectively.

Finally, step S108 is carried out. The third (blue) color light source is turned on according to a third modified duty cycle (the blue modified duty cycle D_{B}′) within the compensation sub-frame period (the compensation sub-frame period 114), wherein the third modified duty cycle (the blue modified duty cycle D_{B}′) is proportioned to the third duty cycle (the blue duty cycle D_{B}).

Note that if only the first and the second color light sources are provided in another embodiment, the step S104 and the step S108 can be skipped. That is, although there are four sub-frames described in the said embodiment, people having ordinary skill in the art can, according to the color sequential display method, utilize more or less sub-frames in comparison with said embodiment. Therefore, the present invention is not limited to the displaying order of the sub-frames, the number of the sub-frames, and colors of the sub-frames. Note that although there are four color sub-frame periods 111 through 114 as described in the embodiment, the sub-frame periods in other numbers can also be applicable in another embodiment. In addition, the number of the sub-frame period is equivalent to the number of the sub-frame.

In summary, said embodiments in FIG. 2A to FIG. 2C provide the display method and the color sequential display that determine the duration of the red, green, and blue modified duty cycles during the compensation sub-frame period, and the duration of the red, green, and blue modified duty cycles respectively is proportioned to the red, green, and blue duty cycles in response to the color temperature of the frame. Therefore, the optical performance of the color sequential display can be enhanced, such that the CBU can be reduced, the white balance can be achieved, and so can the work efficiency of the color sequential display be improved.

Though the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims.

What is claimed is:

1. A display method for a color sequential display to display a frame in a frame period, wherein the frame comprises a plurality of sub-frames, and the frame period comprises a plurality of sub-frame periods corresponding to the sub-frames, the display method comprising:
turning on a first color light source according to a first duty cycle within a first sub-frame period for displaying a first sub-frame;
turning on a second color light source according to a second duty cycle within a second sub-frame period for displaying a second sub-frame; and
respectively turning on the first color light source according to a first modified duty cycle and the second color light source according to a second modified duty cycle within a compensation sub-frame period for displaying a compensation sub-frame,
wherein the first modified duty cycle and the second modified duty cycle are proportioned to the first duty cycle and the second duty cycle.

2. The display method as claimed in claim 1, wherein the first duty cycle and the second duty cycle are determined in response to a color temperature of the frame.

3. The display method as claimed in claim 1, wherein a ratio of the first modified duty cycle to the second modified duty cycle is substantially equal to a ratio of the first duty cycle to the second duty cycle.

4. The display method as claimed in claim 1, wherein the first duty cycle is unequal to the second duty cycle.

5. The display method as claimed in claim 4, wherein the first sub-frame period is unequal to the second sub-frame period in accordance with the first duty cycle and the second duty cycle.

6. The display method as claimed in claim 4, wherein the compensation sub-frame period is determined upon the maximum of the first modified duty cycle and the second modified duty cycle.

7. The display method as claimed in claim 1, further comprising:
turning on a third color light source according to a third duty cycle within a third sub-frame period for displaying a third sub-frame.

8. The display method as claimed in claim 7, wherein the first duty cycle, the second duty cycle, and the third duty cycle are determined in response to a color temperature of the frame.

9. The display method as claimed in claim 7, further comprising:
turning on the third color light source according to a third modified duty cycle within the compensation sub-frame period, wherein the third modified duty cycle is proportioned to the third duty cycle.

10. The display method as claimed in claim 9, wherein a ratio of the first modified duty cycle to the third modified duty cycle is substantially equal to a ratio of the first duty cycle to the third duty cycle.

11. The display method as claimed in claim 9, wherein the compensation sub-frame period is determined upon the maximum of the first modified duty cycle, the second modified duty cycle, and the third modified duty cycle.

12. The display method as claimed in claim 7, wherein colors of the first, the second, and the third color light sources are corresponding to primary colors of light.

13. A color sequential display for displaying a frame in a frame period, wherein the frame comprises a plurality of sub-frames, and the frame period comprises a plurality of sub-frame periods corresponding to the sub-frames, the color sequential display comprising:
a luminaire device for turning on a first color light source according to a first duty cycle within a first sub-frame period, turning on a second color light according to a second duty cycle within a second sub-frame period, and respectively turning on the first color light source according to a first modified duty cycle and the second color light source according to a second modified duty cycle within a compensation sub-frame period;
a control module for determining the first modified duty cycle and the second modified duty cycle respectively proportioned to the first duty cycle and the second duty cycle; and.
a display panel for respectively displaying a first sub-frame, a second sub-frame, and a compensation sub-frame in response to the luminaire device during the first sub-frame period, the second sub-frame period, and the compensation sub-frame period.

14. The color sequential display as claimed in claim 13, wherein the control module determines the first duty cycle and the second duty cycle in response to a color temperature of the frame.

15. The color sequential display as claimed in claim 13, wherein a ratio of the first modified duty cycle to the second modified duty cycle is substantially equal to a ratio of the first duty cycle to the second duty cycle.

16. The color sequential display as claimed in claim 13, wherein the first duty cycle is unequal to the second duty cycle.

17. The color sequential display as claimed in claim 13, wherein the first sub-frame period is unequal to the second sub-frame period in accordance with the first duty cycle and the second duty cycle.

18. The color sequential display as claimed in claim 13, wherein the compensation sub-frame period is determined upon the maximum of the first modified duty cycle and the second modified duty cycle.

19. The color sequential display as claimed in claim 13, wherein the luminaire device further turns on a third color light source according to a third duty cycle within a third sub-frame period, and the display panel displays a third sub-frame during the third sub-frame period.

20. The color sequential display as claimed in claim 19, wherein the luminaire device further turns on the third color light source according to a third modified duty cycle within the compensation sub-frame period, and the control module determines the third modified duty cycle proportioned to the third duty cycle.
